(19) United States
(12) Patent Application Publication
(10) Pub. No.: US 2018/0103649 A1
(43) Pub. Date: Apr. 19, 2018

(54) KELP-CONTAINING SPONGE BISCUIT AND MANUFACTURING METHOD THEREOF

(71) Applicant: Juxiangyuan Health Food (Zhongshan) Co., Ltd, Zhongshan (CN)

(72) Inventors: Yanjie ZHANG, Zhongshan (CN); Zhendong CHEN, Zhongshan (CN); Yu XIA, Zhongshan (CN); Zhigao HU, Zhongshan (CN); Min LI, Zhongshan (CN); Limin FENG, Zhongshan (CN); Minzhi LEI, Zhongshan (CN); Qiaojin WU, Zhongshan (CN)

(21) Appl. No.: 15/706,669

(22) Filed: Sep. 16, 2017

(30) Foreign Application Priority Data
Oct. 17, 2016 (CN) 201610903421.4

(51) Int. Cl. A21D 2/36; A21D 13/80; A21D 2/14

(52) U.S. Cl. CPC A21D 2/36; A21D 2/145; A21D 13/80

(57) ABSTRACT

The invention discloses a kelp-containing sponge biscuit and a manufacturing method thereof. The kelp-containing sponge biscuit comprises following raw materials in parts by weight: 100 parts of high-gluten flour; 10˜18 parts of white sugar; 30˜40 parts of beaten eggs; 0.5˜0.8 part of ammonium bicarbonate; 0.1˜0.3 part of sodium bicarbonate; 5˜15 parts of kelp powder and 12˜15 parts of water. The kelp-containing sponge biscuit further contains 0˜0.3 part of salt and 0˜5 parts of cream. Main steps of the manufacturing method of the kelp-containing sponge biscuit are as follows: weighing the high-gluten flour, the white sugar, the beaten eggs, the ammonium bicarbonate, the sodium bicarbonate, the kelp powder and the fresh water separately in parts by weight; mixing in order, stirring evenly to form a dough; tablet compressing boiling, cooling, draining and baking the dough, and obtaining the kelp-containing sponge biscuit with marine flavor and rich nutrients.

### FIELD OF THE INVENTION

The present invention relates to food technology field, and more specifically, to a kelp-containing sponge biscuit and a manufacturing method thereof.

### BACKGROUND OF THE INVENTION

Kelp is a large algae plant that grows in low temperature seawater and is a seaweed plant that can be used for mixing, burning, stewing, stewing and other cooking methods. Kelp spores are large, brown, flat ribbon, and the length of kelp spores are up to 20 m. A kelp consists of a blade, a shank and a holdfast which is rhizoid. The leaves of the kelp are composed of epidermis, cortex and medullary tissue, and the lower portion of the leaf has sporangia. Kelp has a mucilage cavity which can secrete slippery substances. The holdfast is in the form of a tree branch for attaching on submarine rock. Kelp is generally grown in the sea of the lower water temperature, and is cultivated in the northern coast of China and the coastal Zhejiang province and Fujian province, and the production of kelp in China ranks first in the world.

Kelp is a nutrient-rich marine economic crops and have a certain medicinal value. Kelp is rich in iodine and other mineral elements and can treat low thyroid. Kelp contains rich seaweed polysaccharide and has the function of anti-virus, anti-oxidation, anti-tumor and immunity. Kelp also contains the protein which is easy to be absorbed by animal body and is low calorie. The study found that kelp also has hypolipidemic, hypoglycemic, lead detoxification and other biological functions.

In addition, kelp powder can be used as a feed additive which not only can compensate the lack of nutrients, but also enhance the resistance of aquatic animals.

As one of the main baked goods, sponge biscuits have good nutrition, which is the same as bread, and have advantages of high consumption, long shelf life, easy storage and transportation etc.

### SUMMARY OF THE INVENTION

It is an object of the present invention to provide a kelp-containing sponge biscuit having marine flavor and rich in nutrients and a method for producing the kelp-containing sponge biscuit so as to overcome the deficiencies of the prior art.

A kelp-containing sponge biscuit is made from following raw materials in parts by weight:

| | | |
|---|---|---|
| high-gluten flour | 100 | parts; |
| white sugar | 10~18 | parts; |
| beaten eggs | 30~40 | parts; |
| ammonium bicarbonate | 0.5~0.8 | part; |
| sodium bicarbonate | 0.1~0.3 | part; |
| kelp powder | 5~15 | parts; and |
| fresh water | 12~15 | parts. |

Further, the kelp-containing sponge biscuit further contains 0˜0.3 part of salt.

Further, the kelp-containing sponge biscuit further contains 0˜5 parts of cream.

The manufacturing method comprises the following steps:

step a. weighing following raw materials in parts by weight: 100 parts of high-gluten flour, 10˜18 parts of white sugar, 30˜40 parts of beaten eggs, 0.5˜0.8 part of ammonium bicarbonate, 0.1˜0.3 part of sodium bicarbonate, 5˜15 parts of kelp powder and 12˜15 parts of fresh water separately;

mixing the beaten eggs and the white sugar into a mixer and stirring evenly; adding the ammonium bicarbonate, the sodium bicarbonate and the fresh water and stirring evenly again; finally adding the high-gluten flour and the kelp powder and stirring evenly to obtain a dough, continue stirring until the dough is unsticky and gluten;

step b. tablet compressing the dough repeatedly with a tablet machine, repeatedly folding and recompressing until the dough surface is smooth; or, kneading the dough repeatedly with an automatic kneading machine until the dough surface is smooth;

step c. punch-print moulding the dough to obtain a green body;

step d. putting the green body into water at 100° C. until the green body is floated and a preset floating time is reached, taking out the floated green body and immediately putting into the cold water for soaking and cooling, and draining the soaked and cooled green body to obtain a biscuit body; and the preset floating time is 0.5˜3 minutes; and

step e. putting the biscuit body into a baking tray in batches, putting the baking tray and the biscuit body into an oven under under 240° C. of the upper surface and 180° C. of the lower surface and baking for 15 to 20 minutes; when the surface of the biscuit body is baked like a ball, taking the biscuit body out, cooling and getting a finished product.

Further, step a further comprises adding 0˜0.3 part by weight of salt,

mixing the beaten eggs, the white sugar and the salt into the mixer and stirring evenly; adding the ammonium bicarbonate, the sodium bicarbonate and the fresh water and stirring evenly again; finally adding the high-gluten flour and the kelp powder and stirring evenly to obtain a dough, continue stirring until the dough is unsticky and gluten.

Further, step a further comprises adding 0˜5 parts by weight of cream;

mixing the beaten eggs and the white sugar into the mixer and stirring evenly; adding the ammonium bicarbonate, the sodium bicarbonate and the fresh water and stirring evenly again; stirring and adding cream, finally adding the high-gluten flour and the kelp powder and stirring evenly to obtain a dough, continue stirring until the dough is unsticky and gluten.

Further, step a further comprises adding 0˜0.3 part by weight of cream and 0˜5 part by weight of salt;

mixing the beaten eggs, the white sugar and the salt into the mixer and stirring evenly; adding the ammonium bicarbonate, the sodium bicarbonate and the fresh water and stirring evenly again; stirring and adding cream, finally adding the high-gluten flour and the kelp powder and stirring evenly to obtain a dough, continue stirring until the dough is unsticky and gluten.

Further, the kelp powder is manufactured by following steps: washing fresh kelp with water for 3 to 5 times to remove impurities, soaking for 24 hours and removing fishy smell with cinnamon oil, sun-curing the kelp to little dry, and then cutting the sun-cured kelp into pieces, drying the kelp pieces at 100° C.˜110° C. for 1 to 4 hours until the pieces are without residual water, and finally crushing the dried kelp pieces repeatedly and screening through 100 mesh or 120 mesh sieve, and getting the kelp powder.

The invention creatively combines the marine products with the traditional baked food, and it has both marine flavor and rich nutrition. The obtained kelp-containing sponge biscuit can play a role in the treating of thyroid hypothyroidism, improving immunity, anti-virus, anti-oxidation, anti-tumor, hypolipidemic, hypoglycemic and so on.

### DETAILED DESCRIPTION OF THE INVENTION

The embodiments of the invention is further described.

### Embodiment 1

A kelp-containing sponge biscuit is made from following raw materials in parts by weight:

| | | |
|---|---|---|
| high-gluten flour | 100 | parts; |
| white sugar | 10~18 | parts; |
| beaten eggs | 30~40 | parts; |
| ammonium bicarbonate | 0.5~0.8 | part; |
| sodium bicarbonate | 0.1~0.3 | part; |
| kelp powder | 5~15 | parts; and |
| fresh water | 12~15 | parts. |

Further, the kelp-containing sponge biscuit further contains 0˜0.3 part of salt.

Further, the kelp-containing sponge biscuit further contains 0˜5 parts of cream.

The manufacturing method comprises the following steps:

step a. weighing following raw materials in parts by weight: 100 parts of high-gluten flour, 10˜18 parts of white sugar, 30˜40 parts of beaten eggs, 0.5˜0.8 part of ammonium bicarbonate, 0.1˜0.3 part of sodium bicarbonate, 5˜15 parts of kelp powder and 12˜15 parts of fresh water separately;

mixing the beaten eggs and the white sugar into a mixer and stirring evenly; adding the ammonium bicarbonate, the sodium bicarbonate and the fresh water and stirring evenly again; finally adding the high-gluten flour and the kelp powder and stirring evenly to obtain a dough, continue stirring until the dough is unsticky and gluten;

step b. tablet compressing the dough repeatedly with a tablet machine, repeatedly folding and recompressing until the dough surface is smooth; or, kneading the dough repeatedly with an automatic kneading machine until the dough surface is smooth;

step c. punch-print moulding the dough to obtain a green body;

step d. putting the green body into water at 100° C. until the green body is floated and a preset floating time is reached, taking out the floated green body and immediately putting into the cold water for soaking and cooling, and draining the soaked and cooled green body to obtain a biscuit body; and the preset floating time is 0.5˜3 minutes; and

step e. putting the biscuit body into a baking tray in batches, putting the baking tray and the biscuit body into an oven under 240° C. of the upper surface and 180° C. of the lower surface and baking for 15 to 20 minutes; when the surface of the biscuit body is baked like a ball, taking the biscuit body out, cooling and getting a finished product.

Further, step a further comprises adding 0˜0.3 part by weight of salt,

mixing the beaten eggs, the white sugar and the salt into the mixer and stirring evenly; adding the ammonium bicarbonate, the sodium bicarbonate and the fresh water and stirring evenly again; finally adding the high-gluten flour and the kelp powder and stirring evenly to obtain a dough, continue stirring until the dough is unsticky and gluten.

Further, step a further comprises adding 0˜5 parts by weight of cream,

mixing the beaten eggs and the white sugar into the mixer and stirring evenly; adding the ammonium bicarbonate, the sodium bicarbonate and the fresh water and stirring evenly again; stirring and adding cream, finally adding the high-gluten flour and the kelp powder and stirring evenly to obtain a dough, continue stirring until the dough is unsticky and gluten.

Further, step a further comprises adding 0˜0.3 part by weight of salt and 0˜5 parts by weight of cream;

mixing the beaten eggs, the white sugar and the salt into the mixer and stirring evenly; adding the ammonium bicarbonate, the sodium bicarbonate and the fresh water and stirring evenly again; stirring and adding cream, finally adding the high-gluten flour and the kelp powder and stirring evenly to obtain a dough, continue stirring until the dough is unsticky and gluten.

Further, the kelp powder is manufactured by following steps: washing fresh kelp with water for 3 to 5 times to remove impurities, soaking for 24 hours and removing fishy smell with cinnamon oil, sun-curing the kelp to little dry, and then cutting the sun-cured kelp into pieces, drying the kelp pieces at 100° C.˜110° C. for 1 to 4 hours until the pieces are without residual water, and finally crushing the dried kelp pieces repeatedly and screening through 100 mesh or 120 mesh sieve, and getting the kelp powder.

In this embodiment, step a. weighing 1000 g of high-gluten flour, 150 g of white sugar, 380 g of beaten eggs, 5.5 g of ammonium bicarbonate (ammonia), 1.5 g of sodium bicarbonate (baking soda), 100 g of kelp powder and 130 g of fresh water separately.

mixing the beaten eggs and the white sugar into the mixer and stirring evenly; next continue stirring, and adding the ammonium bicarbonate (ammonia), the sodium bicarbonate (baking soda) and the fresh water and stirring evenly; finally adding the high-gluten flour and the kelp powder and stirring evenly to obtain a dough, continue stirring until the dough is unsticky and gluten.

Step b. tablet compressing the dough repeatedly with a tablet machine, repeatedly folding and recompressing until the dough surface is smooth; or, kneading the dough repeatedly with an automatic kneading machine until the dough surface is smooth, tablet compressing the dough repeatedly with a tablet machine, repeatedly folding and recompressing until the dough surface is smooth, the thickness of the dough is not more than 0.5 cm.

Step c. punch-print moulding the dough to obtain a certain shape of the green body.

Step d. putting the green body into water at 100° C. until the green body is floated, boiling the green body for 0.5 minute, then taking out the floated green body and immediately putting into the cold water for soaking, and cooling for 2 minutes, and finally and draining the soaked and cooled green body to obtain a biscuit body.

Step e. putting the biscuit body into a baking tray in batches, putting the baking tray and the biscuit body into an oven under 240° C. of the upper surface and 180° C. of the lower surface and baking for 15 to 20 minutes; when the surface of the biscuit body is baked like a ball, taking the biscuit body out, cooling and getting a finished product.

The kelp powder is manufactured by washing the fresh kelp with water for 5 times to remove impurities, soaking for 24 hours and removing fishy smell with cinnamon oil, sun-curing the kelp to little dry, and then cutting the sun-cured kelp into pieces, drying the kelp pieces at 100° C.˜110° C. for about 3 hours until the pieces are without residual water, and finally crushing the dried kelp pieces repeatedly and screening through 100 mesh or 120 mesh sieve, and getting the kelp powder. The area of pieces is 0.5˜5 cm².

### Embodiment 2

In this embodiment, step a. weighing 1000 g of high-gluten flour, 150 g of white sugar, 380 g of beaten eggs, 5.5 g of ammonium bicarbonate (ammonia), 1.5 g of sodium bicarbonate (baking soda), 45 g of cream, 100 g of kelp powder and 130 g of fresh water separately.

mixing the beaten eggs and the white sugar into the mixer and stirring evenly; next continue stirring, and adding the ammonium bicarbonate (ammonia), the sodium bicarbonate (baking soda) and the fresh water and stirring evenly, stirring and adding the cream, finally adding the high-gluten flour and the kelp powder and stirring evenly to obtain a dough, continue stirring until the dough is unsticky and gluten.

The rest of the unmentioned portions are described in the first embodiment, so it is not repeated herein.

### Embodiment 3

In this embodiment, step a. weighing following raw materials in parts by weight: 1000 g of high-gluten flour, 160 g of white sugar, 400 g of beaten eggs, 6.5 g of ammonium bicarbonate (ammonia), 2 g of sodium bicarbonate (baking soda), 50 g of cream, 150 g of kelp powder, 130 g of fresh water and 1.75 g of salt separately according to the weight portion.

mixing the beaten eggs, the salt and the white sugar into the mixer and stirring evenly; next continue stirring, and adding the ammonium bicarbonate (ammonia), the sodium bicarbonate (baking soda) and the fresh water and stirring evenly, stirring and adding the cream, finally adding the high-gluten flour and the kelp powder and stirring evenly to obtain a dough, continue stirring until the dough is unsticky and gluten.

The rest of the unmentioned portions are described in the first embodiment, so it is not repeated herein.

### Embodiment 4

In this embodiment, step a. weighing 1000 g of high-gluten flour, 160 g of white sugar, 400 g of beaten eggs, 6.5 g of ammonium bicarbonate (ammonia), 2 g of sodium bicarbonate (baking soda), 50 g of cream, 150 g of kelp powder, 130 g of fresh water and 2 g of salt separately.

mixing the beaten eggs, the salt and the white sugar into the mixer and stirring evenly; next continue stirring, and adding the ammonium bicarbonate (ammonia), the sodium bicarbonate (baking soda) and the fresh water and stirring evenly, stirring and adding the cream, finally adding the high-gluten flour and the kelp powder and stirring evenly to obtain a dough, continue stirring until the dough is unsticky and gluten.

The rest of the unmentioned portions are described in the first embodiment, so it is not repeated herein.

### Embodiment 5

In this embodiment, step a. weighing 1000 g of high-gluten flour, 160 g of white sugar, 400 g of beaten eggs, 5 g of ammonium bicarbonate (ammonia), 2 g of sodium bicarbonate (baking soda), 20 g of cream, 50 g of kelp powder, 130 g of fresh water and 3 g of salt separately.

mixing the beaten eggs, the salt and the white sugar into the mixer and stirring evenly; next continue stirring, and adding the ammonium bicarbonate (ammonia), the sodium bicarbonate (baking soda) and the fresh water and stirring evenly, stirring and adding the cream, finally adding the high-gluten flour and the kelp powder and stirring evenly to obtain a dough, continue stirring until the dough is unsticky and gluten.

The rest of the unmentioned portions are described in the first embodiment, so it is not repeated herein.

### Embodiment 6

In this embodiment, step a. weighing 1000 g of high-gluten flour, 100 g of white sugar, 380 g of beaten eggs, 5.5 g of ammonium bicarbonate (ammonia), 1.5 g of sodium bicarbonate (baking soda), 100 g of kelp powder, 130 g of fresh water and 1.5 g of salt separately.

mixing the beaten eggs, the salt and the white sugar into the mixer and stirring evenly; next continue stirring, and adding the ammonium bicarbonate (ammonia), the sodium bicarbonate (baking soda) and the fresh water and stirring evenly, finally adding the high-gluten flour and the kelp powder and stirring evenly to obtain a dough, continue stirring until the dough is unsticky and gluten.

The rest of the unmentioned portions are described in the first embodiment, so it is not repeated herein.

### Embodiment 7

In this embodiment, step a. weighing 1000 g of high-gluten flour, 180 g of white sugar, 300 g of beaten eggs, 5 g of ammonium bicarbonate (ammonia), 3 g of sodium bicarbonate (baking soda), 100 g of kelp powder, 130 g of fresh water and 2 g of salt separately.

mixing the beaten eggs, the salt and the white sugar into the mixer and stirring evenly; next continue stirring, and adding the ammonium bicarbonate (ammonia), the sodium bicarbonate (baking soda) and the fresh water and stirring evenly, finally adding the high-gluten flour and the kelp powder and stirring evenly to obtain a dough, continue stirring until the dough is unsticky and gluten.

The rest of the unmentioned portions are described in the first embodiment, so it is not repeated herein.

### Embodiment 8

In this embodiment, step a. weighing 1000 g of high-gluten flour, 160 g of white sugar, 380 g of beaten eggs, 5.5 g of ammonium bicarbonate (ammonia), 1.5 g of sodium bicarbonate (baking soda), 110 g of kelp powder, 130 g of fresh water and 1 g of salt separately.

mixing the beaten eggs, the salt and the white sugar into the mixer and stirring evenly; next continue stirring, and adding the ammonium bicarbonate (ammonia), the sodium bicarbonate (baking soda) and the fresh water and stirring evenly, finally adding the high-gluten flour and the kelp powder and stirring evenly to obtain a dough, continue stirring until the dough is unsticky and gluten.

The rest of the unmentioned portions are described in the first embodiment, so it is not repeated herein.

### Embodiment 9

In this embodiment, step a. weighing 1000 g of high-gluten flour, 150 g of white sugar, 380 g of beaten eggs, 5.5 g of ammonium bicarbonate (ammonia), 1.5 g of sodium bicarbonate (baking soda), 35 g of cream, 120 g of kelp powder and 140 g of fresh water separately.

mixing the beaten eggs and the white sugar into the mixer and stirring evenly; next continue stirring, and adding the ammonium bicarbonate (ammonia), the sodium bicarbonate (baking soda) and the fresh water and stirring evenly, stirring and adding the cream finally adding the high-gluten flour and the kelp powder and stirring evenly to obtain a dough, continue stirring until the dough is unsticky and gluten.

The rest of the unmentioned portions are described in the first embodiment, so it is not repeated herein.

### Embodiment 10

In this embodiment, step a. weighing 1000 g of high-gluten flour, 150 g of white sugar, 380 g of beaten eggs, 5.5 g of ammonium bicarbonate (ammonia), 1.5 g of sodium bicarbonate (baking soda), 5 g of cream, 150 g of kelp powder and 150 g of fresh water separately.

mixing the beaten eggs and the white sugar into the mixer and stirring evenly; next continue stirring, and adding the ammonium bicarbonate (ammonia), the sodium bicarbonate (baking soda) and the fresh water and stirring evenly, stirring and adding the cream finally adding the high-gluten flour and the kelp powder and stirring evenly to obtain a dough, continue stirring until the dough is unsticky and gluten.

The rest of the unmentioned portions are described in the first embodiment, so it is not repeated herein.

Above disclosure and description shows the basic principles, main features and the advantages of the present invention. It should be understood by those skilled in the art that the present invention is not limited by the above-described embodiments, and that the principles described in the above examples and specification are illustrative of the principles of the invention. Without departing from the spirit and scope of the invention, various changes and modifications are within the scope of the invention as claimed. It is intended that the scope of the invention be defined by the appended claims and their equivalents.

What is claimed is:

1. A kelp-containing sponge biscuit, wherein the biscuit is made from following raw materials in parts by weight:

| | | |
|---|---|---|
| high-gluten flour | 100 | parts; |
| white sugar | 10~18 | parts; |
| beaten eggs | 30~40 | parts; |
| ammonium bicarbonate | 0.5~0.8 | part; |
| sodium bicarbonate | 0.1~0.3 | part; |
| kelp powder | 5~15 | parts; and |
| fresh water | 12~15 | parts. |

2. The kelp-containing sponge biscuit according to claim 1, wherein the kelp-containing sponge biscuit further contains 0˜0.3 part of salt.

3. The kelp-containing sponge biscuit according to claim 1, wherein the kelp-containing sponge biscuit further contains 0˜5 parts of cream.

4. A manufacturing method of the kelp-containing sponge biscuit of claim 1, wherein the manufacturing method comprises the following steps:
step a. weighing following raw materials in parts by weight: 100 parts of high-gluten flour, 10˜18 parts of white sugar, 30˜40 parts of beaten eggs, 0.5˜0.8 part of ammonium bicarbonate, 0.1˜0.3 part of sodium bicarbonate, 5˜15 parts of kelp powder and 12˜15 parts of fresh water separately;
mixing the beaten eggs and the white sugar into a mixer and stirring evenly; adding the ammonium bicarbonate, the sodium bicarbonate and the fresh water and stirring evenly again; finally adding the high-gluten flour and the kelp powder and stirring evenly to obtain a dough, continue stirring until the dough is unsticky and gluten;
step b. tablet compressing the dough repeatedly with a tablet machine, repeatedly folding and recompressing until the dough surface is smooth; or, kneading the dough repeatedly with an automatic kneading machine until the dough surface is smooth;
step c. punch-print moulding the dough to obtain a green body;
step d. putting the green body into water at 100° C. until the green body is floated and a preset floating time is reached, taking out the floated green body and immediately putting into the cold water for soaking and cooling, and draining the soaked and cooled green body to obtain a biscuit body; and the preset floating time is 0.5˜3 minutes; and
step e. putting the biscuit body into a baking tray in batches, putting the baking tray and the biscuit body into an oven under 240° C. of the upper surface and 180° C. of the lower surface and baking for 15 to 20 minutes; when the surface of the biscuit body is baked like a ball, taking the biscuit body out, cooling and getting a finished product.

5. The manufacturing method of the kelp-containing sponge biscuit of claim 4, wherein step a further comprises adding 0˜0.3 part by weight of salt,
mixing the beaten eggs, the white sugar and the salt into the mixer and stirring evenly; adding the ammonium bicarbonate, the sodium bicarbonate and the fresh water and stirring evenly again; finally adding the high-gluten flour and the kelp powder and stirring evenly to obtain a dough, continue stirring until the dough is unsticky and gluten.

6. The manufacturing method of the kelp-containing sponge biscuit of claim 4, wherein in step a further comprises adding 0˜5 parts by weight of cream;
mixing the beaten eggs and the white sugar into the mixer and stirring evenly; adding the ammonium bicarbonate, the sodium bicarbonate and the fresh water and stirring evenly again; stirring and adding cream, finally adding the high-gluten flour and the kelp powder and stirring evenly to obtain a dough, continue stirring until the dough is unsticky and gluten.

7. The manufacturing method of the kelp-containing sponge biscuit of claim 4, wherein step a further comprises adding 0˜5 parts by weight of cream and 0˜0.3 parts by weight of salt;
mixing the beaten eggs, the white sugar and the salt into the mixer and stirring evenly; adding the ammonium bicarbonate, the sodium bicarbonate and the fresh water and stirring evenly again; adding the high-gluten flour and the kelp powder and stirring evenly to obtain a dough, continue stirring until the dough is unsticky and gluten.

8. The manufacturing method of the kelp-containing sponge biscuit of claim 4, wherein the kelp powder is manufactured by following steps: washing fresh kelp with water for 3 to 5 times to remove impurities, soaking for 24 hours and removing fishy smell with cinnamon oil, sun-curing the kelp to little dry, and then cutting the sun-cured kelp into pieces, drying the kelp pieces at 100° C.˜110° C. for 1 to 4 hours until the pieces are without residual water, and finally crushing the dried kelp pieces repeatedly and screening through 100 mesh or 120 mesh sieve, and getting the kelp powder.

9. The manufacturing method of the kelp-containing sponge biscuit of claim 5, wherein the kelp powder is manufactured by following steps: washing fresh kelp with water for 3 to 5 times to remove impurities, soaking for 24 hours and removing fishy smell with cinnamon oil, sun-curing the kelp to little dry, and then cutting the sun-cured kelp into pieces, drying the kelp pieces at 100° C.˜110° C. for 1 to 4 hours until the pieces are without residual water, and finally crushing the dried kelp pieces repeatedly and screening through 100 mesh or 120 mesh sieve, and getting the kelp powder.

10. The manufacturing method of the kelp-containing sponge biscuit of claim 6, wherein the kelp powder is manufactured by following steps: washing fresh kelp with water for 3 to 5 times to remove impurities, soaking for 24 hours and removing fishy smell with cinnamon oil, sun-curing the kelp to little dry, and then cutting the sun-cured kelp into pieces, drying the kelp pieces at 100° C.˜110° C. for 1 to 4 hours until the pieces are without residual water, and finally crushing the dried kelp pieces repeatedly and screening through 100 mesh or 120 mesh sieve, and getting the kelp powder.

11. The manufacturing method of the kelp-containing sponge biscuit of claim 7, wherein the kelp powder is manufactured by following steps: washing fresh kelp with water for 3 to 5 times to remove impurities, soaking for 24 hours and removing fishy smell with cinnamon oil, sun-curing the kelp to little dry, and then cutting the sun-cured kelp into pieces, drying the kelp pieces at 100° C.˜110° C. for 1 to 4 hours until the pieces are without residual water, and finally crushing the dried kelp pieces repeatedly and screening through 100 mesh or 120 mesh sieve, and getting the kelp powder.
